(19) United States
(12) Patent Application Publication
(10) Pub. No.: US 2017/0334446 A1
(43) Pub. Date: Nov. 23, 2017

(54) Semi-automated lane changing

(71) Applicant: Continental Teves AG & Co. oHG, Frankfurt (DE)

(72) Inventors: Sybe Dirk Jan Bosch, Neu-Isenburg (DE); Oliver Fochler, Frankfurt (DE); Stefan Lüke, Rosbach vor der Höhe (DE); Matthias Strauss, Pfungstadt (DE)

(73) Assignee: Continental Teves AG & Co. oHG, Frankfurt (DE)

(21) Appl. No.: 15/669,303

(22) Filed: Aug. 4, 2017

Related U.S. Application Data
(63) Continuation of application No. PCT/DE2016/200007, filed on Jan. 13, 2016.

(30) Foreign Application Priority Data
Apr. 2, 2015 (DE) 10 2015 201 878.4

(51) Int. Cl. B60W 30/18; B60W 10/04; G08G 1/01; G08G 1/04; B60W 50/14; B60W 10/20; B60W 30/095; B60W 30/14; B60W 50/10; G08G 1/052; B60W 10/18

(52) U.S. Cl. CPC B60W 30/18163; G08G 1/052; B60W 10/04; G08G 1/0137; G08G 1/04; B60W 10/18; B60W 10/20; B60W 30/0956; B60W 30/143; B60W 50/10; B60W 50/14; B60W 2050/146; B60W 2420/52; B60W 2420/54; B60W 2520/10; B60W 2550/10; B60W 2550/302; B60W 2550/306

(57) ABSTRACT

The invention relates to a lane change assistant for a vehicle comprising a sensor arrangement for calculating information relating to lanes and other road users. Provided is an arithmetic and logic unit for calculating movement paths for a first lane change and a subsequent second lane change to the original lane. The vehicle driver can accept or initiate the calculated lane changes. An actuator unit can then execute the lane changes calculated by the arithmetic and logic unit and initiated by the vehicle driver upon receipt of a signal from the arithmetic and logic unit.

### CROSS-REFERENCE TO RELATED APPLICATIONS

This application claims the benefit of PCT International application No. PCT/DE2016/200007, filed Jan. 13, 2016, which claims priority to German patent application No. 10 2015 201 878.46 filed Feb. 4, 2015, each of which is hereby incorporated by reference herein.

### TECHNICAL FIELD

The invention relates to a lane change assistant for a vehicle, as well as a vehicle and a method for executing semi-automated, double lane changing.

### BACKGROUND

Lane change assistants can be offered as an additional feature of a lane departure warning system. A system which automatically carries out such an action and, at the same time, even makes the decision to carry out the action, is called an autonomous system. In autonomous lane change systems, huge outlay is required for the sensor technology for monitoring the surroundings and traffic, since a lane change always constitutes a safety-critical action which, in the case of a fully automatic system, is carried out by the vehicle itself.

A driver assistance system having an autonomous lane change system can therefore only be integrated into commercial vehicles with great outlay. Such an autonomous lane change assistant would have to be able to capture detailed information about the road users in the area surrounding the vehicle and approaching vehicles, in order to effectively avoid accidents. In addition, full knowledge of the lanes and directions of travel in these lanes is also necessary for such a system.

In addition, partly automated lane change systems are known, in which the driver assistance system does indeed carry out a single lane change automatically, but only on receipt of a command from the driver.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An object of the invention is to create a safe and inexpensive driver assistance system for changing lanes, which largely relieves the burden on the driver.

According to one aspect, a lane change assistant for a vehicle is indicated. The lane change assistant thereby comprises a sensor arrangement, wherein the sensor arrangement is designed to calculate information relating to lanes and other road users. The lane change assistant further comprises an arithmetic and logic unit, wherein the arithmetic and logic unit is designed to calculate movement paths for a first lane change from the original lane to an adjacent second lane and a subsequent second lane change back to the original lane. In addition, an input unit is provided, wherein the input unit is designed to capture an input from the vehicle driver and to transmit it to the arithmetic and logic unit. Finally, the lane change assistant comprises an actuator unit, wherein the actuator unit is designed to execute lane changes calculated by the arithmetic and logic unit and initiated by the vehicle driver upon receipt of a signal from the arithmetic and logic unit.

The lane change assistant can, in particular, be designed as an overtaking assistant.

The sensor arrangement can, for example, include a radar arrangement which makes it possible to capture other road users and to observe their movements. In this case, it is not mandatory to have sensors in all directions, as could be the case, for example, in autonomous systems. Instead, sensors can be directed towards the sides of the vehicle and towards the front, into the main direction of travel of the vehicle. The system can also include sensors directed diagonally towards the back. The sensor arrangement detects traffic, in order to detect other road users and to capture their behavior. An element of behavior can be e.g. the speed of the other road users. The position in the lanes and changes in direction of the other road users may also be of importance. In addition to radar equipment, lidar sensors or ultrasonic sensors can also be used.

The arithmetic and logic unit calculates the anticipated movement paths which the vehicle has to follow in the event of the lane changes. The anticipated movement paths can be completely calculated even before the start of the first lane change. The movement paths are smoothed target trajectories for changing lanes, on the one hand, and for remaining in the lane, on the other hand. One limiting factor of the time in which the lane change takes place can be the maximum permissible lateral acceleration which occurs at the seat of the vehicle driver. This is also crucial for safety in adverse weather conditions such as rain, snow or an icy road.

The arithmetic and logic unit can, for instance, be designed, with the appropriate sensor technology, to adjust the movement paths. However, the narrowest allowable curve radius of the lane change primarily depends on the speed of the vehicle. In addition, the arithmetic and logic unit coordinates all of the processes with peripheral elements or devices such as the sensor arrangement, the actuator unit or the notification unit.

The input unit is a part of the so-called “Human Machine Interface” and waits for inputs from the vehicle driver. The input unit can consist of one or more controls. To this end, a distinction is to be made between two categories. On the one hand, the input unit can be a control which is not intended to operate the vehicle in the sense of steering or adjusting the speed. For instance, the direction-indicator control can be this input unit, wherein the initiation of the calculated lane change is implemented by the vehicle driver by actuating the direction-indicator control. This can be, for example, indicating itself, or a separate function on the direction-indicator control. Other input units may also be provided such as separate buttons, switches, or voice control.

However, the input unit can, on the other hand, also be a control for operating the vehicle such as the steering wheel, wherein in this case the calculated lane change can be initiated as a result of the vehicle driver moving the steering wheel in the appropriate direction. The lane change assistant then takes over the overtaking maneuver which is executed without any further intervention on the part of the vehicle driver. It may be necessary for certain conditions to be placed on this movement of the steering wheel, for example with regard to displacement. However, each displacement of the steering wheel in the direction of the first calculated lane change can also be interpreted as an initiation of the lane change process, especially if a lane departure warning system is active beforehand and manual steering is therefore generally not necessary.

If the vehicle driver has transmitted an appropriate signal to the input unit, the input unit forwards the signal to the arithmetic and logic unit. The arithmetic and logic unit can then coordinate the planned lane changes.

The actuator unit controls the vehicle movements by means of appropriate actions of force. Possible ways of influencing the trajectories can be increasing the engine power, braking or steering. Actuators can be located on one or more of the control elements for operating the vehicle. In addition to steering actuators, which regulate the steering angles of the coupled wheels, a suitable controlling element on the engine can be one, for instance, which adjusts the engine power following a regulation. The brake can also have an actuator which is controlled by means of the arithmetic and logic unit. For example, when the vehicle goes back into the original lane. The actuator unit is usually equipped with an appropriate range, in order to execute the dynamic maneuvers as specified by the arithmetic and logic unit. A sensor on the actuators may, in addition, be indicated for capturing saturations, which sensor reports back to the arithmetic and logic unit whether the lane changes can be executed as planned by the arithmetic and logic unit. This may, in particular, affect the acceleration in the main direction of travel if, for instance, a heavy trailer or heavy load capacity of the vehicle renders a commanded acceleration unattainable, even at maximum engine power.

According to the aspect, a vehicle carries out an overtaking maneuver with two automatic lane changes and in response to just one action of the driver at the start of the first lane change.

Therefore, complex sensor technology such as that for autonomous vehicles is not required, but the workload for a driver is nevertheless reduced.

According to one embodiment, the lane change assistant further comprises a notification unit, wherein the notification unit is designed to communicate information about the calculated lane changes to the vehicle driver.

The notification unit is installed in the vehicle and issues a notification to the vehicle driver. This can be effected by an acoustic signal. For example, a sound or a series of sounds, which can be clearly allocated to the lane change event, is produced. This can also take place through visual indications. For example, the possible lane changes are displayed to the vehicle driver by means of a head-up display or a head-down display. Signals can also be transmitted, for instance, to the controls of the vehicle by means of haptic signals. For instance, the steering wheel can automatically specify a small movement in the direction of the first lane change or the steering wheel is made to vibrate.

According to another embodiment, the lane change assistant is designed to carry out both lane changes completely autonomously after precisely one confirmation of the information communicated by the notification unit by the vehicle driver prior to initiating the first lane change.

Precisely one confirmation from the vehicle driver can mean that both lane changes, i.e. the lane change to an overtaking lane and the second lane change back to the original lane, are effected on the basis of just one confirmation. This confirmation usually takes place prior to the initiation of the first lane change and after the notification unit has displayed the planned lane changes.

The inputs can be effected in response to the information from the notification unit. This can be substantially effected at the same time as, or, for example, a short time after the transmission of the information by the notification unit. The time for the possible input following a notification can be limited to a predefined limit, in order to guarantee that the lane change takes place in a timely fashion, as planned in the arithmetic and logic unit.

According to another embodiment, the actuator unit is designed to increase the speed of the vehicle before and during the first lane change and to reduce the speed during and after the second lane change. For example, the engine power of the vehicle is increased following the input by the vehicle driver and on the initiation of the first lane change, in order to increase the speed during an overtaking maneuver. This can be conductive to safety, for example, on country roads where there is only limited visibility or where oncoming traffic is to be expected. When swinging into the original lane, it can be expedient to reduce the speed again, in order to prevent collisions with further vehicles. However, it can also be that the increased speed is only slightly reduced or is not reduced at all, namely for instance, if the speed of the obstacles overtaken is much slower than the permitted speed, and the current conditions also allow driving at the permitted speed.

According to another embodiment, the lane change assistant is designed not to carry out the second lane change to the original lane if the sensor arrangement provides the arithmetic and logic unit with information about detected obstacles in the original lane.

If, for example, an obstacle is overtaken and a further obstacle is only detected during this overtaking maneuver, which is located at such a short distance from the first obstacle that going back safely into the original lane does not seem to be possible, the arithmetic and logic unit can initially discard and postpone the second lane change.

According to another embodiment, the lane change assistant is designed not to carry out the second lane change to the original lane if the sensor arrangement provides the arithmetic and logic unit with information about one or more vehicles in the second lane which are moving more slowly than the target speed of the driver's own vehicle, at least if said vehicles are located within a minimum distance from the driver's own vehicle.

It can also be provided that this information is only provided if a minimum distance from one or more vehicles in the second lane is fallen below. For example, the lane change assistant can be designed such that in the case of several lanes leading in the same direction, no change back to the original lane takes place if the speed of the vehicles traveling in front in the second lane is slower than the set target speed. This prevents the vehicle changing back too frequently and having to find a gap again in the second lane for each new obstacle in the original lane. The target speed of the vehicle can be set in a cruise control of the driver assistance system.

According to another embodiment, the lane change assistant further comprises a storage unit, wherein the storage unit comprises a digital map containing information relating to the number of lanes and is designed to provide this information to the arithmetic and logic unit, and wherein the lane change assistant is designed to only calculate the lane change if at least two lanes are stored in the digital map. For example, the two lane changes are not calculated if the digital map transmits information to the arithmetic and logic unit that, for example, only one lane is available, as a result of which a lane change is excluded.

According to another embodiment, the lane change assistant is designed to only calculate the lane changes if the second lane is a lane for the current main direction of travel of the vehicle in the original lane.

In this embodiment, the lane changes are only calculated if the two lanes available are also intended for the same direction of travel. This is, for instance, the case on motorways or on expressways with structurally separated lanes of traffic.

According to another embodiment, the lane change assistant is designed to only calculate the lane changes if the second lane is the faster lane.

If vehicles drive on the right in a country, the left lane is usually the faster lane, i.e. the overtaking lane. Overtaking using the right lane is frequently prohibited by law. Therefore, the lane change is only calculated in this embodiment if overtaking using the left lane is possible. In this way, dangerous situations or contraventions of the law, for example by overtaking in the right lane, can be avoided.

According to another embodiment, the lane change assistant is designed to only calculate the lane change if the arithmetic and logic unit calculates sufficient space for the vehicle in the second lane.

If, for example, the second lane is narrow and the vehicle is wider than is necessary to safely change to this lane, the arithmetic and logic unit can discard the calculated lane changes or not carry out said lane changes at all.

According to another embodiment, the lane change assistant is designed to only carry out the lane change if the time calculated for executing the path falls below a pre-defined length of time.

A limited period of time of the overtaking maneuver may be important depending on the surroundings or traffic situation. If the vehicle is located, for example, on a country road, oncoming traffic is to be expected and a faster overtaking maneuver will be safer. The predefined length of time can be implemented statically, i.e. it can be stored in the arithmetic and logic unit or storage unit such that it cannot be altered, or dynamically, for example it can be adjusted to the information from the digital map. The calculation of the length of time up to the completion of the two lane changes can, for example, be adapted to the situation if, for instance, the combination of an engine torque sensor or a similar sensor having an acceleration sensor produces a vehicle total mass which is higher than average.

According to another aspect n, a vehicle having a lane change assistant as described is indicated.

According to another aspect, a method for a vehicle for executing a first lane change and a subsequent second lane change to the original lane of the vehicle is indicated, wherein a sensor arrangement calculates information relating to lanes and other road users, and wherein an arithmetic and logic unit calculates movement paths for the first lane change and the subsequent second lane change to the original lane, and wherein a vehicle driver performs an input at the input unit, and wherein an actuator unit executes lane changes determined by the arithmetic and logic unit and confirmed by the vehicle driver upon receipt of a signal from the arithmetic and logic unit by means of steering movements of the vehicle.

According to another aspect of the invention, a programming element is indicated which, if it is run on an arithmetic and logic unit of a lane change assistant, prompts the lane change assistant to execute the method.

According to another aspect, a computer-readable medium is indicated, on which the programming element is stored.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a schematic representation of a method according to one embodiment of the invention;

FIG. 2 shows a schematic representation of a vehicle having suitable devices according to one embodiment of the invention; and

FIG. 3 shows a schematic representation of the lane changes according to one embodiment of the invention.

### DETAILED DESCRIPTION

The representation in the figures is schematic and is not true to scale. If the same reference numerals are used in the various figures, these denote the same or similar elements.

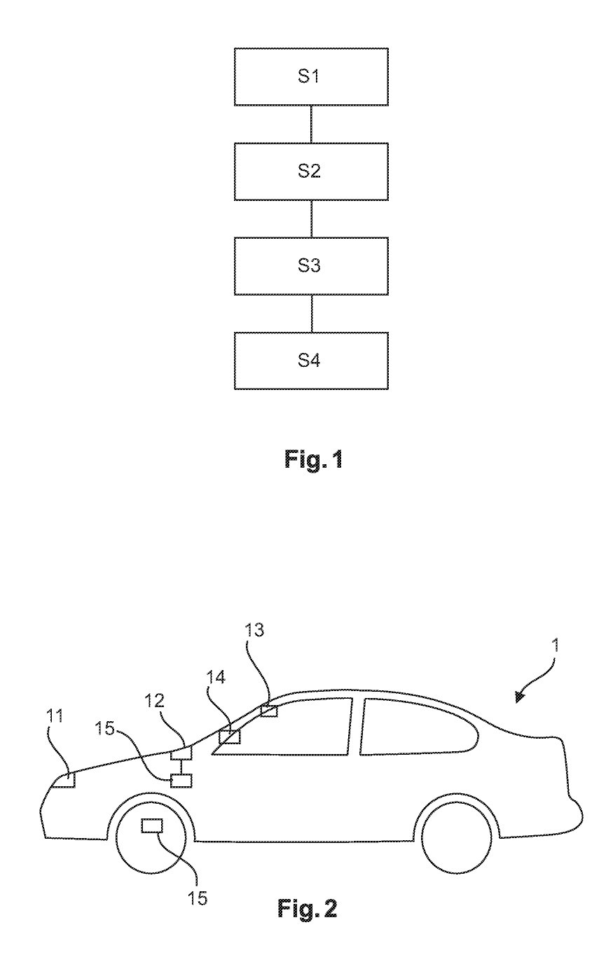

FIG. 1 shows a method for a vehicle 1 for executing a first lane change 21 and a subsequent second lane change 22 to the original lane of the vehicle 1. This method comprises the following steps: calculation S1 of information relating to lanes 50a, 50b and other road users by a sensor arrangement 11; calculation S2 of movement paths for the first lane change 21 and the subsequent second lane change 22 to the original lane 50a by an arithmetic and logic unit 12; performance S3 of an input at an input unit (14) by the vehicle driver; and execution S4 of the lane changes 21, 22 calculated by the arithmetic and logic unit 12 and initiated by the vehicle driver upon receipt of a signal from the arithmetic and logic unit 12 by the actuator unit 15 by means of steering movements of the vehicle 1.

FIG. 2 shows a vehicle 1 having a lane change assistant comprising a sensor arrangement 11, an arithmetic and logic unit 12, a notification unit 13, an input unit 14, and an actuator unit 15.

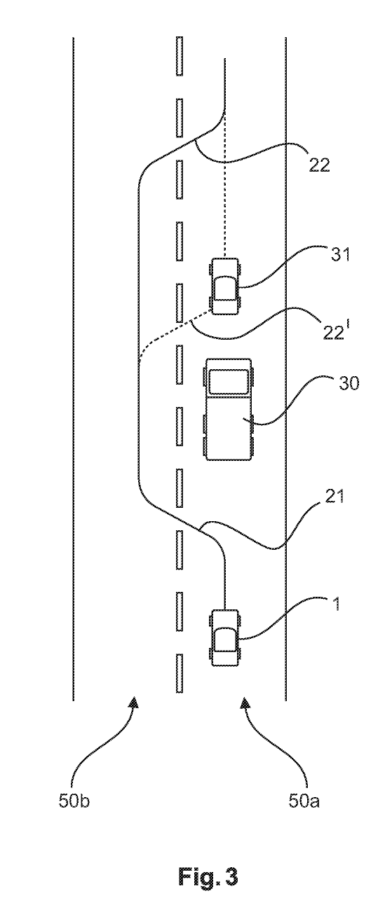

FIG. 3 shows one possible embodiment example for carrying out the lane changes with a vehicle 1. To this end, there are two lanes, the right lane 50a and the left lane 50b. The vehicle may initially be located in the right lane 50a in this example, when the obstacle 30 is detected by the sensor arrangement 11. The right lane 50a is therefore the original lane. In this example, the left lane 50b is a second lane in the same direction as the first lane 50a. The example applies to countries in which vehicles drive on the right.

The first lane 50a is thus nominally the slower lane, and the second lane 50b is the nominal overtaking lane. Since the speed of the vehicle 1 is greater than the speed of the obstacle 30, and the sensor arrangement 11 of the vehicle 1 also detects this, the arithmetic and logic unit 12 calculates a possible overtaking maneuver which consists of two lane changes 21, 22. Since those sensors of the sensor arrangement 11, which are directed towards the side and slightly diagonally towards the rear, do not detect any further obstacles in the second lane 50b, this is observed to be free.

The arithmetic and logic unit 12 therefore calculates two lane changes 21, 22, with the second lane change 22 being directed back to the right lane 50a, and sends a notification signal to the notification unit 13. The notification unit 13 communicates the possible lane changes 21, 22 to the vehicle driver. Subsequently, the vehicle driver can himself decide, possibly after examining the traffic situation, whether he agrees to the proposed lane changes 21, 22. If the vehicle driver agrees to the proposed lane changes 21, 22, he communicates this to the vehicle 1 by means of the input unit 14. A signal with the information affirming the possible lane changes is transmitted to the arithmetic and logic unit 12 by the input unit 14. The arithmetic and logic unit 12 can then forward suitable signals to the actuator unit 15 in order to carry out the lane changes 21, 22.

It may be possible that the arithmetic and logic unit 12 and the actuator unit 15, together with the sensor arrangement 11, continue to interact during the carrying out of the lane changes 21, 22, since it is basically a control engineering task to also make the lane changes 21, 22 as planned. This may require some corrections by the actuator unit 15, since it is impossible to capture all of the disturbance variables completely from the outset. Examples of disturbance variables can be gusts from the side, road surface undulations, unevenness of the road surface, and asymmetry in the wheel suspension or curves in the road, which the actuators on the vehicle steering can counter.

Following a positive confirmation, the first lane change 21 is then initiated by steering the vehicle 1, in particular by the actuator unit 15. The positive confirmation by the vehicle driver may, in this example, be provided by actuating the direction-indicator control, i.e. by indicating left. The lane change 21 can be composed, for example, of two arcs in opposite directions and one transient phase each at the start and at the end of the lane change 21 and in the reversal of the steering direction from “steer left” to “steer right”. The vehicle 1 is then located in the second lane 50b and accelerates as of the first lane change 21. The sensor arrangement detects that the obstacle 30 has been passed and reports this to the arithmetic and logic unit 12.

The arithmetic and logic unit 12 continues to list the second lane change 22′ as a task which still has to be carried out, which is to be executed as soon as the obstacle 30 has been overtaken at a sufficient distance. However, in this example, after passing the obstacle 30, the sensor arrangement 11 may detect a further obstacle 31 and, at the same time, capture the distance between the obstacle 30 and the obstacle 31, and transmit this to the arithmetic and logic unit 12. In this example, the distance between the two obstacles 30, 31 is estimated by the arithmetic and logic unit as being too short to carry out a safe second lane change 22′ behind the first obstacle 30. The lane change 22′ is therefore discarded by the arithmetic and logic unit, and a second lane change 22 behind the second obstacle 31 is scheduled by the arithmetic and logic unit 12. This can also be communicated to the vehicle driver by means of the notification unit 13. The vehicle 1 therefore remains in the second lane 50b until the sensor arrangement 11 transmits the overtaking of the obstacle 31 at a sufficient distance to the arithmetic and logic unit 12.

Once this event has occurred, the arithmetic and logic unit 12 transmits a command to change lanes to the actuator unit 15, wherein this lane change 22 is directed back to the original lane 50a of the vehicle 1. The vehicle 1 therefore automatically carries out the second lane change 22 and is back in the original lane 50a.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A lane change assistant for a vehicle comprising:
a sensor arrangement designed to calculate information relating to lanes and other road users,
an arithmetic and logic unit designed to calculate movement paths for a first lane change and a subsequent second lane change to the original lane,
an input unit designed to capture an input from the vehicle driver and to transmit it to the arithmetic and logic unit, and
an actuator unit designed to execute the lane changes calculated by the arithmetic and logic unit and initiated by the vehicle driver upon receipt of a signal from the arithmetic and logic unit.

2. The lane change assistant of claim 1, further comprising a notification unit designed to communicate information about the calculated lane changes to the vehicle driver.

3. The lane change assistant of claim 2, wherein the lane change assistant is designed to carry out both lane changes upon receipt of one confirmation of the information communicated by the notification unit by the vehicle driver prior to initiation of the first lane change.

4. The lane change assistant of claim 1, wherein the actuator unit increases the speed of the vehicle before and during the first lane change and reduces the speed during and after the second lane change.

5. The lane change assistant of claim 1, wherein the lane change assistant is designed not to carry out the second lane change to the original lane when the sensor arrangement provides the arithmetic and logic unit with information about detected obstacles in the original lane.

6. The lane change assistant of claim 1, wherein the lane change assistant is designed not to carry out the second lane change to the original lane when the sensor arrangement provides the arithmetic and logic unit with information about at least one vehicle in the second lane, which the at least one vehicle is moving more slowly than the target speed of the vehicle.

7. The lane change assistant of claim 1, further comprising:
a storage unit, wherein the storage unit comprises a digital map containing information relating to the number of lanes and is designed to provide this information to the arithmetic and logic unit, and
wherein the lane change assistant is designed to calculate the movement paths for the lane changes only when at least two lanes are stored in the digital map.

8. The lane change assistant of claim 7, wherein the lane change assistant is designed to only calculate the movement paths for the lane changes when the second lane is a lane for the current main direction of travel of the vehicle in the original lane.

9. The lane change assistant of claim 8, wherein the lane change assistant is designed to only calculate the movement paths for the lane changes when the second lane is the faster lane.

10. The lane change assistant of claim 7, wherein the lane change assistant is designed to only calculate the movement paths for the lane changes when the arithmetic and logic unit calculates sufficient space for the vehicle in the second lane.

11. The lane change assistant of claim 1, wherein the lane change assistant is designed to only carry out the lane changes when the time calculated for executing the movement paths falls below a pre-defined length of time.

12. A method for a vehicle for executing a first lane change and a subsequent second lane change to the original lane of the vehicle comprising:
calculating information relating to lanes and other road users with a sensor arrangement;
calculating movement paths for the first lane change and the subsequent second lane change to the original lane with an arithmetic and logic unit;
wherein the vehicle driver performs an input at the input unit; and
executing the lane changes calculated by the arithmetic and logic unit and initiated by the vehicle driver upon receipt of a signal from the arithmetic and logic unit by steering movements of the vehicle controlled by an actuator unit.

13. The method of claim 12, further comprising prompting the lane change assistant to execute with a programming element, run on the arithmetic and logic unit.

14. The method of claim 13, further comprising a computer-readable medium, on which a programming element is stored.

15. A vehicle proving a lane change assistant comprising;
a sensor arrangement designed to calculate information relating to lanes and other road users,
an arithmetic and logic unit designed to calculate movement paths for a first lane change and a subsequent second lane change to the original lane,
an input unit designed to capture an input from the vehicle driver and to transmit it to the arithmetic and logic unit, and
an actuator unit designed to execute the lane changes calculated by the arithmetic and logic unit and initiated by the vehicle driver upon receipt of a signal from the arithmetic and logic unit.

16. The vehicle of claim 15, further comprising a notification unit designed to communicate information about the calculated lane changes to the vehicle driver.

17. The vehicle of claim 16, wherein the lane change assistant is designed to carry out both lane changes upon receipt of one confirmation of the information communicated by the notification unit by the vehicle driver prior to initiation of the first lane change.
